(19) United States
(12) Patent Application Publication
(10) Pub. No.: US 2006/0183392 A1
(43) Pub. Date: Aug. 17, 2006

(54) Polishing and buffing pad

(75) Inventors: Gary M. Silvers, Mission Viejo, CA (US); Claude Sevigny, Laval (CA); Robert Bergman, Gurnee, IL (US)

Correspondence Address: PILLSBURY WINTHROP SHAW PITTMAN LLP, P.O BOX 10500, McLean, VA, 22102, US

(73) Assignee: MEGUIAR'S INC., Irvine, CA (US)

(21) Appl. No.: 11/405,373

(22) Filed: Apr. 17, 2006

Related U.S. Application Data
(62) Division of application No. 10/925,703, filed on Aug. 24, 2004.
(60) Provisional application No. 60/505,266, filed on Sep. 22, 2003.

(51) Int. Cl. B32B 5/18; D04B 1/22; D04B 21/20

(52) U.S. Cl. 442/308; 442/315; 442/312

(57) ABSTRACT

A buffing and polishing pad or other structure uses extremely fine microfibers of less than 1 denier. Preferred fibers are less than 0.7 denier, and in some cases considerably less. The currently most preferred embodiment is 50% fiber having 0.5 denier and 50% fiber having 0.3 denier. Preferred fibers have an average fiber length of between about 70 and about 90 mm, and most preferably about 80 mm. The fibers can be any suitable material, natural or synthetic, including especially polyester. A layer of the fibers is preferably made on a circular knitting machine.

### RELATED APPLICATION DATA

This is a divisional of application Ser. No. 10/925,703, filed Aug. 24, 2004, which claims priority to provisional application Ser. No. 60/505,266, filed Sep. 22, 2003, the entire contents of which are incorporated herein by reference.

### FIELD OF INVENTION

The field of the invention is polishing and buffing pads.

### BACKGROUND

Buffing and polishing pads are well known in automotive and other industries.

There have been many different designs over the years, in overall configuration of the pad, attachment of the pad to a backing, material used for the pad, and configuration of the working fibers.

In the automobile industry buffing and polishing pads have often utilized tufted materials, those having looped fibers without exposed free ends. Unfortunately, such materials tend to trap dirt and spent buffing compounds in the fiber surface, which can cause swirl or whorl marks in the finished surface. Such pads also have a tendency to mat when the surface becomes clogged with dirt and/or spend buffing compound, and can require frequent changing as well as frequent cleaning.

Some more modern pads use flocked fibers instead. Flocked fibers have one end attached to a substrate and a second free end. Where flocked fibers are used, the fibers are generally stiffer to resist bending and matting. A typical automotive buffing pad, for example, contains fibers having a caliper of about 15-20 denier. U.S. Pat. No. 5,815,876 to Overseth (October 1998), for example, teaches the use of special trilobal fibers at about 18 denier. This and all other patents and applications referenced herein are incorporated by reference in their entirety. While such pads may be acceptable for use on original automotive painted surfaces, such fibers tend to be too aggressive when used on other paint surfaces, e.g., the softer after-market air-dried or low-bake paints normally used in body repair shops. The potential problem is especially severe where the buffing pad is used with a power tool that can rotate the pad at more than 1,500 rpm.

A contrary solution is set forth in U.S. Pat. No. 5,292,567 to Foster (March 1994). Foster contemplates using softer fibers than 15 denier, and contemplates preferred fiber thickness of about 11 dtex. (about 9.9 denier). The specification mentions very thin fibers, of 1.5, 3.3, 6.7, 8.9, 11 and so forth, but then goes on to point out that buffing pads formed from fibers that are finer than about 6.7 dtex (about 6 denier) are unacceptable because they have poor adhesion for the hook-face attachment surfaces of the back-up pad and are often displaced during use.

What has not been appreciated, however, is that buffing and polishing pads can be made with even softer fibers, having denier of less than 1. It has also not been appreciated that such fibers can even be properly coupled to an attachment layer. Thus, there is still a need for devices and methods for producing buffing and polishing pads having a buffing layer with a fiber thickness of 1.

### SUMMARY OF THE INVENTION

The present invention provides devices and methods in which a buffing and polishing pad or other structure uses extremely fine microfibers of less than 1 denier.

Preferred fibers are less than 0.7 denier, and in some cases considerably less. The currently most preferred embodiment is 50% fiber having 0.5 denier and 50% fiber having 0.3 denier. Preferred fibers have an average fiber length of between about 70 and about 90 mm, and most preferably about 80 mm. The fibers can be any suitable material, natural or synthetic, including especially polyester.

The buffing layer is preferably made on a circular knitting machine.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is a vertical cross-section of a buffing pad utilizing the ultra-soft fibers as described herein.

FIG. 2 is a side view of a buffing machine to which is attached the buffing pad of FIG. 1.

FIG. 3 is a sponge with a cloth covering that utilizes the ultra-soft fibers.

### DETAILED DESCRIPTION

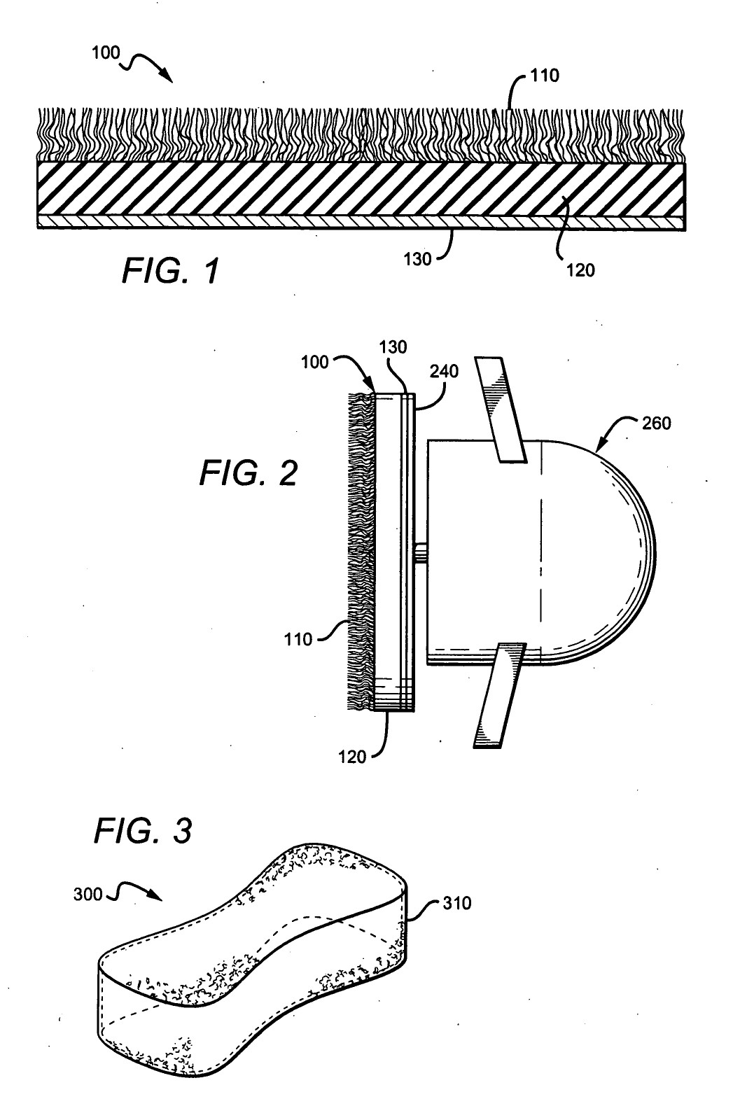

Referring to FIG. 1, a preferred buffing and polishing pad 100 comprises a buffing layer 110, a backing layer 120, and a coupling or attachment layer 130. To avoid pedantic distinctions, the term “buffing and polishing pad” is used herein interchangeably with the term “buffing pad”.

In overall design, buffing pads can have different thicknesses depending upon specific application. Generally, however, the pads are formed with a thickness in the range from 3 to 8 mm, preferably in the range from 4 to 6 mm, with a typical value being about 5 mm. Although buffing pads may be constructed outside of this range, pads less than 3 mm thick tend to lack sufficient structural integrity for prolonged use and for pads greater than 8 mm thick there is no further practical advantage to be gained without the cost of manufacture becoming uneconomical.

The buffing layer 110 preferably comprises a microfiber material, i.e., a material that is fibrous and comprises a polymer. The fibers may be formed from natural materials, such as, for example, wool, cotton and other cellulosic materials, and synthetic polymers and co-polymers such as, for example, polyamides, polyacrylates, polyesters, nylons and viscose. Of particular interest here are man-made fibers comprising pure polyester, and mixtures of polyester and polyamide. The buffing layer can comprise a single fiber type or a mixture of two or more fibers. The fibers may be crimped or non-crimped.

Ideally, the material is woven in such a way as to create a magnetic “dinginess” that picks up dirt, and may have fibers that are split in such a way as to create microscopic “hooks” that act as claws to scrape up and hold dust, dirt, and grime. In preferred embodiments, at least 50% of the fibers comprise polyester, and in more preferred embodiments, at least 90% of the fibers comprise polyester. At present, the most preferred embodiment utilizes 100% polyester fibers. Cross-sections of the fibers will usually be substantially circular, but other shapes are also contemplated, including oblong and even the trilobal shapes discussed in the Overseth patent. Preferred fibers for the buffing layer have an average fiber length (pile height) of at least 50 mm, and more preferably an average fiber length of between about 70 and about 90 mm. This and all other ranges set forth herein are to be construed as including their endpoints. At present, the most preferred fibers are those having an average fiber length of about 80 mm.

The fibers for the buffing layer have an average fiber thickness of less than 1 denier. In preferred embodiments, at least 80% of the fibers have a fiber thickness of between 0.2 denier and 0.6 denier. Viewed from another perspective, at least 25% of the fibers have a fiber thickness of less than 0.7 denier, and at least 25% of the fibers have a fiber thickness of less than 0.5 denier. In more preferred embodiments, at least 25% of the fibers have a fiber thickness of less than 0.6 denier, and at least 25% of the fibers have a fiber thickness of less than 0.4 denier. In the currently most preferred embodiments, about 50% of the fibers have a fiber thickness of 0.5 denier, and about 50% of the fibers have a fiber thickness of about 0.3 denier.

In an exemplary class of pads, the fibers have an average fiber length of between about 70 and about 90 mm, at least 25% of the fibers have a fiber thickness of less than 0.7 denier, and at least 25% of the fibers have a fiber thickness of less than 0.5 denier. In another exemplary class the fibers have an average fiber length of between about 70 and about 90 mm, and at least 80% of the fibers have a fiber thickness of between 0.2 denier and 0.6 denier. In still another exemplary class the fibers have an average fiber length of about 80 mm, about 50% of the fibers have a fiber thickness of 0.5 denier, and about 50% of the fibers have a fiber thickness of about 0.3 denier. In still another exemplary class, at least some of the fibers are man-made, have an average fiber length of between about 70 and about 90 mm, and at least 80% of the fibers have a fiber thickness of between 0.2 denier and 0.6 denier. In each of these exemplary classes of pads, the microfibers of the buffing layer are natural color, (with no dyes), they have no backcoating, and the buffing layers are preferably made using a circular knitting machine.

In an exemplary manufacturing process, IV-C is cut to 3/16″ thickness. The Velcro™ loop and IV-C is then roll coated with PUR glue. Next, the IV-C is again roll coated with PUR glue, and the KPW-2 10 microfiber is attached. After moisture curing, the sheets are then cut into 3.1875″ OD or 5.250″ OD disks.

The backing layer 120 is the pad core, and is used as the interface between the buffing layer and a backing plate (240 in FIG. 2). Backing layer 120 may comprise any material or combination of materials but is preferably made from foam, plastic, or rubber. The most currently preferred material for the core is IV-C Ensolite™ closed cell sponge rubber. The fibers of the buffing layer can be attached to the backing layer using any suitable method. The current preference is to use a polyurethane (PUR) hot melt, with moisture cure (non-thermoplastic).

Coupling layer 130 is adapted to couple the pad to another surface, such as a backing plate 240 of FIG. 2. Any suitable mechanism can be used here, with the current preference being a Velcro™ or other hook and loop type fastening mechanism. From a pure mechanical perspective, either the hook or the loop side could be present on the pad. But from a practical standpoint it is much better for the softer loop portion to be present on the pad. Suitable hookface attachment surfaces generally comprise in the range from 50 to 120 filaments/cm², preferably in the range from 60 to 100 filaments/cm², the filaments having an average height in the range from 0.75 to 1.5 mm, preferably in the range from 0.9 to 1.3 mm; an average diameter in the range from 0.15 to 0.35 mm, preferably in the range from 0.2 to 0.3 mm; and an average head diameter in the range from 0.4 to 0.75 mm, preferably in the range from 0.55 to 0.65 mm. A preferred hook and loop fastener is Velcro™ 100% knitted nylon loop tape 3610, black loop with added binder.

As discussed in the Foster patent, it may be advantageous for the pad to undergo a manufacturing treatment in which a bonding agent is applied throughout the structure to provide further structural integrity and to reduce the propensity of the material to lint during use. The bonding agent is conveniently applied by immersing the material in a bath of liquid bonding agent followed by drying, e.g., in an air tunnel or with infrared heaters. Suitable commercially available bonding agents include, for example, polyvinyl alcohol, polyvinyl acetate, acrylic emulsions, butadiene-acrylo nitrile copolymer and other water-dispersible lattices. It is contemplated that the bonding agent can be employed as a 15 to 25%, typically 20% by weight of solids dispersed in water.

In FIG. 2, a buffing pad 100 is connected to backing plate 240, which is attached to buffing machine 260. Backing plate 240 is preferably substantially stiffer than backing layer 120, providing support to keep surface buffing layer flat while it is being moved by machine 260. Machine 260 can be any suitable device, including a buffing orbital or a rotary machine. Such movement may be “planar” such as spinning the assembly about a central axis, or may involve three dimensional/non-planar movement.

FIG. 3 depicts a sponge 300 having a cloth covering 310 that includes the ultra-soft microfibers described herein. The same figure was included and described in U.S. Ser. No. 10/868,532. Also contemplated are buffing and polishing mitts or gloves, or other surface care products including such microfibers, whether or not especially directed to automobile care. Although typically disadvantageous in most instances, it may be desirable to impregnate the pad, or coat the fibers, with an active chemical. Exemplary such additives are described in U.S. Pat. No. 5,605,749 to Pike et al. (February 1997).

Thus, specific embodiments and applications of polishing and buffing pads have been disclosed, which have extremely soft fibers. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A method of manufacturing a buffing pad, said method comprising:
providing a buffing layer, a backing layer, and an attachment layer, each of said layers having respective front and back sides, and said buffing layer being circular knitted and having, on its front side, fibers with an average fiber thickness of less than 1.0 denier;
coupling the backing layer's front side to the buffing layer's back side with polyurethane (PUR) hot melt glue;
coupling the backing layer's back side to the attachment layer's front side with PUR hot melt glue; and
allowing the PUR glue between the backing layer and the buffing layer and the PUR glue between the backing layer and the attachment layer to moisture cure so as to eliminate the need for a backcoating.

2. The method of claim 1, wherein the back side of the attachment layer has an attachment means adapted for coupling to said buffing machine.

3. The method of claim 1, wherein the backing layer is made of closed cell sponge rubber.

4. The method of claim 3, wherein about 50% of the buffing layer's fibers have a thickness of about 0.5 denier, and about 50% of the fibers have a thickness of about 0.3 denier.

5. The method of claim 4, wherein all of the buffing layer's fibers are made of 100% polyester.

6. The method of claim 5, wherein the buffing layer's fibers have a substantially circular cross-section.
